(19) United States
(12) Patent Application Publication
(10) Pub. No.: US 2005/0018648 A1
(43) Pub. Date: Jan. 27, 2005

(54) Infrared signal distribution and management system and method

(76) Inventor: Erik Scheelke, Cupertino, CA (US)

Correspondence Address: Thomas B. Haverstock;HAVERSTOCK & OWENS LLP, 162 North Wolfe Road, Sunnyvale, CA, 94086, US

(21) Appl. No.: 10/846,332

(22) Filed: May 14, 2004

Related U.S. Application Data
(60) Provisional application No. 60/470,768, filed on May 14, 2003.

(51) Int. Cl. H04L 12/28

(52) U.S. Cl. 370/351

(57) ABSTRACT

An apparatus for and method of distributing and reproducing infrared signals within a digital network is disclosed. The apparatus comprises a control unit for digitizing a received infrared signal command from a wireless remote and transmitting the digitized signal over the digital network. The apparatus also comprises at least one transceiver device coupled to the network and identified by the control unit to receive the digitized signal and reproduce the infrared signal as originally received. The transceiver device can provide the reproduced infrared signal to at least one electronic device located within a vicinity of the transceiver device.

### RELATED APPLICATIONS

This Patent Application claims priority under 35 U.S.C. 119(e) of the co-pending U.S. Provisional Patent Application Ser. No. 60/470,768, filed May 14, 2003, and entitled “DISTRIBUTION AND REPRODUCTION OF INFRARED SIGNALS IN A NETWORK”. The Provisional Patent Application Ser. No. 60/470,768, filed May 14, 2003, and entitled “DISTRIBUTION AND REPRODUCTION OF INFRARED SIGNALS IN A NETWORK” is also hereby incorporated by reference.

### FIELD OF THE INVENTION

The present invention relates generally to networks for controlling electronic devices. More specifically, the present invention relates to an apparatus for and method of distributing and reproducing infrared signals to control a plurality of remotely located devices within a digital network.

### BACKGROUND OF THE INVENTION

Consumer electronic devices are commonly remotely controlled through the use of coded infrared signals. However, the remote controls for these devices typically require a line of sight between the user and the electronic device.

Modern homes contain multiple consumer electronic devices that can benefit from interconnection to other electronic devices in the home, for example, displaying the output of a DVD player located in a living room on a television located in a bedroom. As the number of interoperable electronic devices in the home environment increases, the need arises for a way to control all of the electronic devices in the household remotely and to allow the devices to interact remotely.

A problem encountered when attempting to control multiple electronic devices remotely is that the infrared signal must travel from room to room if the user is in a different room from the device or if multiple devices in different rooms need to be controlled simultaneously. In the past, this problem has been addressed by broadcasting signals and using repeaters to boost the signals in order to reach devices located in a different room from the infrared signal transmitter. Drawbacks to this method include: infrared noise from the environment interfering with the commanded signal, difficulty differentiating between devices of the same make and model, and difficulties arising when more than one user tries to share the same device. In addition, using repeaters for communicating with multiple electronic devices located in more than two rooms creates a broadcast environment where signals feedback and interfere with each other.

To accommodate flexibility in accessing and controlling multiple electronic devices, a new apparatus and method is needed for the distribution and reproduction of infrared signals to control remote electronic devices within a home network.

### SUMMARY OF THE INVENTION

The present invention discloses an apparatus and method of distributing and reproducing infrared signals within a digital network. The present invention overcomes the drawbacks of broadcasting signals and using repeaters to boost the signals to control electronic devices located in rooms away from a transmitter and receiver unit. The present invention receives an infrared signal command from a wireless remote control, digitizes the received infrared signal, transmits the digitized signal across a digital network, and reproduces the infrared signal as originally received.

In accordance with one embodiment of the present invention, an apparatus for distributing and reproducing infrared signals within a digital network is disclosed. The apparatus comprises a control unit for digitizing a received infrared signal command from a wireless remote and transmitting the digitized signal over the digital network. The apparatus also comprises at least one transceiver device coupled to the network and identified by the control unit to receive the digitized signal and reproduce the infrared signal as originally received.

Preferably, the transceiver device provides the reproduced signal to at least one electronic device located within a vicinity of the at least one transceiver device. The at least one transceiver device can be hard wire coupled to the electronic device. The electronic device can include means for establishing a transmissions link with any one of the electronic devices. The control unit can include means for establishing a direct transmissions link with any one of the electronic devices. The control unit can stagger the sending of two or more control signals to the at least one transceiver device to reduce the impact of simultaneously reproducing the control signals. The transceiver device can include means for establishing a direct transmissions link with any one of the at least one transceiver device.

The digital network can be wired. Alternatively, the digital network can be wireless. The digital network can also be a powerline. The electronic device can comprise at least one of: a DVD player, a CD player, a cable box receiver, a satellite box receiver, a personal video recorder (PVR), a laserdisc player, a television, a personal computer, a home stereo, a home theater system, a game console, a personal digital assistant (PDA), and a mobile telephone.

In accordance with another embodiment of the present invention, a method of distributing and reproducing infrared signals within a digital network is disclosed. The method includes the step of digitizing a received infrared signal. The method further includes the step of transmitting the digitized signal over the digital network. The method also includes the step of reproducing the infrared signal as originally received. The method can also include the step of sending the reproduced infrared signal to at least one electronic device. The method can also include the step of staggering the sending of two or more control signals to reduce the impact of simultaneously reproducing the control signals.

In accordance with another embodiment of the present invention, an apparatus for distributing and reproducing infrared signals within a digital network is disclosed. The apparatus includes means for digitizing a received infrared signal and transmitting the digitized signal over the digital network. The apparatus also includes means for receiving the digitized signal and reproducing the infrared signal as originally received.

The means for digitizing and transmitting can comprise a control unit. The means for receiving and reproducing can comprise at least one transceiver device. The apparatus can also include means for displaying the reproduced infrared signal as originally received. The means for displaying can include at least one electronic device located within a vicinity of the means for receiving the digitized signal.

In accordance with another embodiment of the present invention, an apparatus for controlling a plurality of electronic devices locatable in at least two rooms within a building and coupled to a digital network is disclosed. The apparatus includes a control unit coupled to the network for digitizing a received infrared signal and transmitting the digitized signal over the network to communicate with a plurality of transceiver devices coupled to the electronic device, thereby establishing a two way communication between the control unit and the transceiver devices, wherein the transceiver devices reproduce the infrared signal as originally received and send the infrared signals to the electronic devices to be controlled.

In accordance with another embodiment of the present invention, a method of controlling a plurality of devices locatable in at least two rooms within a building and coupled over a digital network. The method includes the step of digitizing a received infrared signal. The method further includes the step of transmitting the digitized signal over the network to communicate with a plurality of transceiver devices coupled to the electronic devices. The method also includes the steps of reproducing the infrared signal as originally received; and sending the infrared signal to the electronic devices to be controlled.

In another embodiment of the present invention, an infrared signal distribution and management system for controlling electronic devices is disclosed. The system comprises at least one network IR device coupled to each electronic device to be controlled and an IR management element for accepting commands from a user. The network IR device includes means for emitting coded infrared signals to control the electronic devices, means for being uniquely addressable, and means for addressing each network IR device to communicate signals. The IR management element includes means for emitting the coded infrared signals to control the electronic devices directly, and means for addressing and instructing the network IR device to emit infrared signals to control the electronic devices. The system further includes means for transmitting information between the electronic devices. The means for transmitting can be at least one of a local area network, a wide area network, or a cable network.

The electronic devices can have identical make and model type, and respond to identical sequences of the coded infrared signals. The network IR devices are preferably comprised of infrared circuitry for sensing infrared activity; infrared circuitry for emitting infrared signals; and network chips for addressing and communicating with the IR management element, each network IR device, and the electronic devices. The IR management element preferably comprises a user interface and microprocessor circuitry for instructing the network IR device to emit the coded infrared signals for controlling the electronic devices.

In accordance with another embodiment of the present invention, a method of distributing and managing infrared signals to control electronic devices is provided. The method comprises the steps of: a) receiving commands from a user through an IR management element; b) sending instructions from the IR management element to network IR devices; c) sending signals between the network IR devices; d) emitting coded infrared signal commands to the electronic devices to be controlled; and e) transmitting information between the electronic devices.

In accordance with another embodiment of the present invention, an infrared signal distribution and management system to control electronic devices is disclosed. The system comprises means for receiving commands from a user through an IR management element and means for sending instructions from the IR management element to network IR devices. The system also includes means for sending signals between the network IR devices. The system further includes means for emitting infrared signal commands from the IR management element and the network IR devices to the electronic devices to be controlled and means for transmitting information between the electronic devices.

### BRIEF DESCRIPTION OF THE DRAWINGS

FIG. 1 shows a system for controlling a plurality of electronic devices locatable in at least two rooms within a building and coupled to a digital network in accordance with the present invention.

FIG. 2 is a block diagram of an apparatus for distributing and reproducing infrared signals within a digital network in accordance with the present invention.

FIG. 3 is a flow chart illustrating a method of distributing and reproducing infrared signals within a digital network in accordance with the present invention.

### DETAILED DESCRIPTION OF A PREFERRED EMBODIMENT

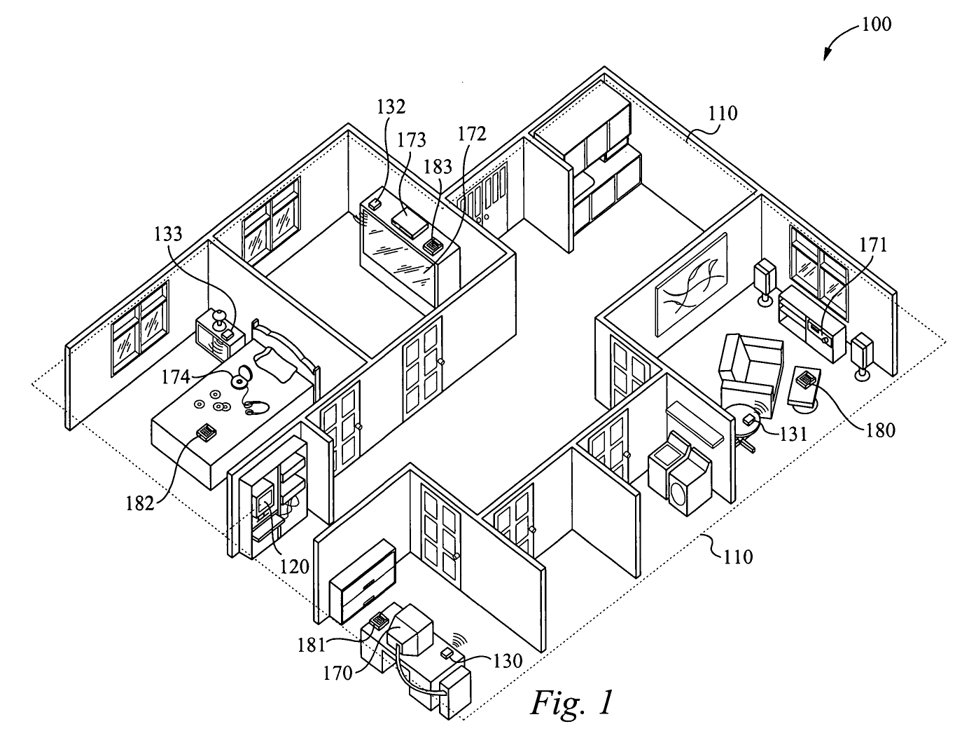

FIG. 1 illustrates a system for controlling a plurality of electronic devices locatable in at least two rooms within a building and coupled to a digital network according to the present invention. The system 100 includes a network 110, an IR management element or control unit 120, and a plurality of IR network devices or transceiver devices 130, 131, 132 and 133. The system 100 controls a plurality of electronic devices 170, 171, 172, 173 and 174 according to commands from a user with a wireless remote. FIG. 1 shows an example with four rooms included in the system 100. In this example, the electronic device 170 is personal computer. The electronic device 171 is a home stereo. The electronic devices 172 and 173 are a television and cable box receiver, respectively. The electronic device 174 is a CD player. A plurality of IR interface devices 180, 181, 182 and 183 are operated by a user to request an action by one of the electronic devices 170-174. The IR interface devices 180-183 can each be a unique so-called “clicker” provided by the manufacturer of each of the electronic devices 170-174. However, preferably the IR interface devices 180-183 are universal devices configured to operate in the system of the present invention.

When a user chooses to remotely control one or more of the plurality of electronic devices 170 to 174 remotely, the user enters an infrared signal command from one of the IR interface devices 180-183 to the control unit 120. The control unit 120 digitizes the infrared signal and transmits the digitized signal over the network 110. In one embodiment, the control unit 120 identifies an appropriate transceiver device 130-133 for receiving the digitized signal located in the same room or zone of the electronic device 170-174 to be controlled. Each transceiver device 130-133 is capable of receiving digitized signals, reproducing the infrared signal as originally received, and providing the reproduced signal to at least one electronic device 170-174 located within a vicinity of the appropriate transceiver device 130-133. Alternatively, the control unit 120 can emit the infrared signal directly to an electronic device when the electronic device to be controlled is located in the same room or zone of the control unit 120.

The network 110 couples the control unit 120 and the plurality of transceiver devices 130-133 in the system 100 to enable communication between them; signals or information can be sent between the control unit 120 and the plurality of transceiver devices 130-133 and also between the transceiver devices 130-133. For example, if the control unit 120 fails, the transceiver devices 130-133 can communicate between themselves with information pre-programmed by the control unit 120 in advance of failure. The network 110 can be wired. Alternatively, the network 110 can be wireless. The network 110 can also be a powerline.

In a preferred embodiment, each of the transceiver devices 130-133 can be individually addressable and distinguishable from any other transceiver device 130-133 with use of network protocols, so that when the digitized signal is transmitted over the network 110, only the selected transceiver device 130-133 responds. In a preferred embodiment, when the control unit 120 receives and digitizes a received infrared signal from a user with an IR interface device 180-183, the control unit 120 intelligently identifies and decides which transceiver device 130-133 shall receive the digitized signal, reproduce the infrared signal as originally received and send the reproduced infrared signal to the electronic device as requested by the user. Thus, the control unit 120 sends electronic instructions over the network 110 to the appropriate transceiver device or devices 130-133 to control the electronic device or devices 170-174 selected by the user using appropriate protocols.

The control unit 120 can also stagger sending control signals to each transceiver device 130-133 by a predetermined time period to avoid reproducing two or more simultaneous commands at the same time. For example, if a first user requests to control the stereo 171 from the room where the stereo 171 is located and a second user, simultaneously, requests to control the stereo 171 from a remote location, the control unit 120 will stagger sending the signals to the transceiver device 132 to avoid reproducing the simultaneous control requests.

The transceiver devices 130-133 comprise infrared circuitry (not shown) for sensing infrared activity and emitting infrared signals. The transceiver devices 130-133 also comprise network circuitry (not shown) for addressing and communicating with the control unit 120 and with any other transceiver device 130-133. As mentioned, the transceiver device 130-133 preferably receive instructions from the control unit 120 and send appropriate signals to operate the electronic device 170-174 selected according to commands from the user. A benefit of having each individual transceiver device 130-133 configured to be individually addressed, allows for multiple electronic devices of the same make and model to be controlled within the system 100. Thus, in FIG. 1, the transceiver device 130 can provide a requested infrared signal command to control the computer 170; the transceiver device 131 can provide a requested infrared signal command to control the home stereo 171; the transceiver device 132 can provide a requested infrared signal command to control the television 172 and/or the cable box receiver 173; and the transceiver device 133 can provide a requested infrared signal command to control the CD player 174, whether the user requesting that operation is located in the same room or another room.

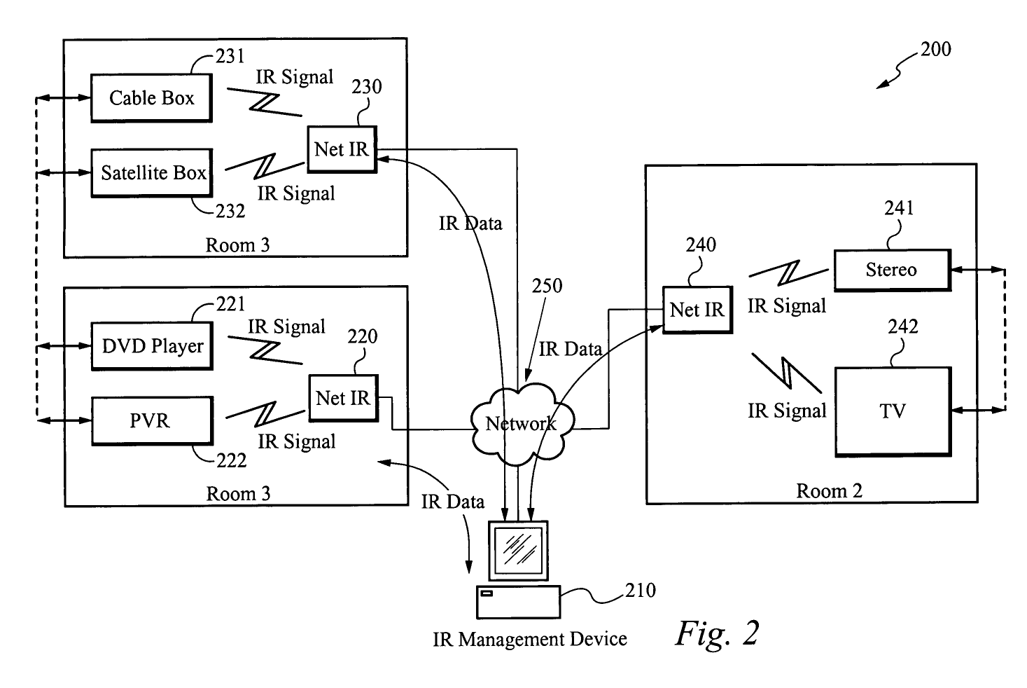

FIG. 2 is a block diagram of an apparatus 200 for distributing and reproducing infrared signals within a digital network in accordance with one embodiment of the present invention. A control unit 210 accepts user input signals from a wireless remote and distributes the signals in digitized form to control a plurality of transceiver devices 220, 230 and 240 and electronic devices 221, 222, 231, 232, 241 and 242 coupled to a digital network 250. The control unit 210 communicates with the transceiver devices 220, 230, 240 that are coupled to the network 250, as shown. Each transceiver device 220, 230, 240 is coupled to control at least one electronic device, as shown. For example, the transceiver device 220 controls and is coupled to the electronic devices 221 and 222. The transceiver device 230 controls and is coupled to the electronic devices 231 and 232. The transceiver device 240 controls and is coupled to the electronic devices 241 and 242. The control unit 210 preferably determines which transceiver device is coupled to which electronic device or devices that the user wants to control. The control unit 210 then transmits a signal or signals to the transceiver device that is coupled to the electronic device to be controlled. Note that the number of electronic devices each transceiver device can control is not limited to two electronic devices, as shown in FIG. 2. The apparatus 200 can include an unlimited number of transceiver devices and electronic devices. The control unit 210 is also capable of directly emitting infrared signals directly to any electronic device located within a same room or vicinity as the control unit 210. The control unit 210 can be aimed to have its IR signal point toward the transceiver device 220, 230 and 240 of the selected electronic device 221, 222, 231, 232, 241 and 242. Alternatively, a fibre optic cable can deliver the IR signal directly into the transceiver device 220, 230 and 240. Preferably, the control unit 210 can drive an IR LED mounted to the transceiver device 220, 230 and 240 of the electronic device 221, 222, 231, 232, 241 and 242. Further, if an electronic device 221, 222, 231, 232, 241 and 242 needs to interact with any other electronic device 221, 222, 231, 232, 241 and 242 or devices in the network 250, audio, video, and data signals can be sent along a signal bus 260 that is coupled to all of the electronic devices 221, 222, 231, 232, 241 and 242.

The signal bus 260 couples outputs of any one of the plurality of electronic devices 221, 222, 231, 232, 241 and 242. The signal bus can comprise an electrical transmission cabling such as a coaxial cable or optical transmission cabling, including a fiber optic cable, which carries and distributes network signals such as audio, video, and data signals. The transmission cabling can be same as cabling used for the network for communication between the control unit 210 and the transceiver devices 220, 230 and 240. The signal bus allows any one of the plurality of electronic devices 221, 222, 231, 232, 241 and 242 to operate in conjunction with any other of the plurality of electronic devices 221, 222, 231, 232, 241 and 242 when “dual electronic device operation” is needed. For example, if a user requests that an output of a DVD player 221 be displayed on a television 242, the DVD player 221 can transmit the output through the signal bus 260 to the television 242. The control unit 210, in this example, can command a first transceiver device 220 to provide the infrared signal to control the DVD player 221 to turn on, play a DVD, and transmit the DVD output to the signal bus 260, while simultaneously commanding a second transceiver device 240 to turn the television 242 on and display the output generated by the DVD player 221. The system, therefore, allows a user to remotely control multiple electronic devices that respond to infrared signals without the need for the user to be physically present in the same room as the device to be controlled.

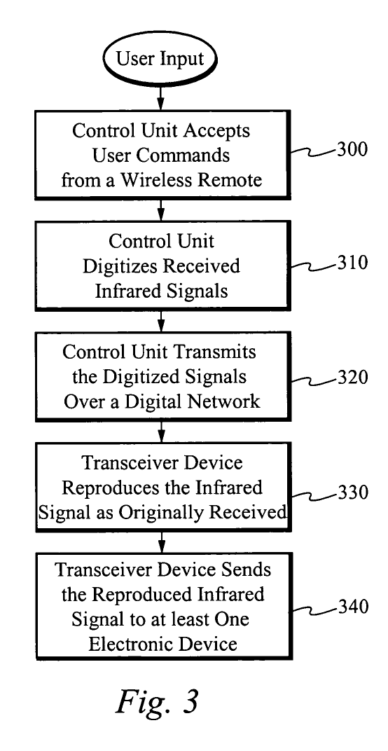

FIG. 3 is a flow chart illustrating a method of distributing and reproducing infrared signals within a digital network in accordance with the present invention. In the step 300 a control unit receives user commands from a wireless remote. The user commands are preferably infrared signals. Next, in the step 310, the control unit digitizes the received infrared signals and, in step 320, transmits the digitized signals over a digital network. The digital network can be wired. Alternatively, the digital network can be wireless. The digital network can also be a powerline. Next, in the step 330, a transceiver device receives the digitized signals and reproduces the infrared signals as originally received. Preferably, each of the transceiver devices coupled to the network is uniquely addressable and thus distinguishable from any other transceiver device in the network. Preferably, the transceiver devices each reside in the same room or location as one or more electronic devices to be controlled. The electronic devices can comprise a DVD player, a CD player, a cable box receiver, a satellite box receiver, a personal video recorder (PVR), a laserdisc player, a personal computer, a home stereo, a home theater system, a game console, a personal digital assistant (PDA), and a mobile telephone. In the step 340, the transceiver device appropriately selected by the control unit sends the reproduced infrared signal to the electronic device to be controlled. Thus, the infrared signals from the user are transmitted by the control unit to the transceiver device that is closest to receiving and then sending the infrared signals to a particular electronic device to be controlled. Multiple commands may be sent by the control unit to multiple transceiver devices to control multiple electronic devices. The control unit can also stagger sending control signals to a transceiver device by a predetermined time period to avoid reproducing two or more simultaneous commands at the same time.

The electronic devices can transmit signals to one another to implement the user's commands. For example, an electronic device can directly transmit audio, video, or data signals along a signal bus for use by another electronic device on the network.

This invention has been described in terms of specific embodiments incorporating details to facilitate the understanding of the principles of construction and operation of the invention. Such reference herein to specific embodiments and the details thereof is not intended to limit the scope of the claims appended hereto. It will be apparent to those of ordinary skill in the art that modifications can be made in the embodiment chosen for illustration without departing from the spirit and scope of the invention.

1. An apparatus for distributing and reproducing infrared signals within a digital network, the apparatus comprising:
a. a control unit for digitizing a received infrared signal command from a wireless remote and transmitting the digitized signal over the digital network; and
b. at least one transceiver device coupled to the network and identified by the control unit to receive the digitized signal and reproduce the infrared signal as originally received.

2. The apparatus of claim 1 wherein the at least one transceiver device provides the reproduced infrared signal to at least one electronic device located within a vicinity of the at least one transceiver device.

3. The apparatus of claim 2 wherein the at least one transceiver device is hard wire coupled to the at least one electronic device.

4. The apparatus of claim 2 wherein the at least one electronic device includes means for establishing a transmissions link with any one of the at least one electronic devices.

5. The apparatus of claim 2 wherein the control unit includes means for establishing a direct transmissions link with any one of the at least one electronic device.

6. The apparatus of claim 1 wherein the at least one transceiver device includes means for establishing a direct transmissions link with any one of the at least one transceiver device.

7. The apparatus of claim 1 wherein the network is wired.

8. The apparatus of claim 1 wherein the network is wireless.

9. The apparatus of claim 1 wherein the network is a powerline.

10. The apparatus of claim 2 wherein the at least one electronic device comprises at least one of: a DVD player, a CD player, a cable box receiver, a satellite box receiver, a personal video recorder (PVR), a laserdisc player, a television, a personal computer, a home stereo, a home theater system, a game console, a personal digital assistant (PDA), and a mobile telephone.

11. The apparatus of claim 1, wherein the control unit staggers the sending of two or more control signals to the at least one transceiver device to reduce the impact of simultaneously reproducing the control signals.

12. A method of distributing and reproducing infrared signals within a digital network, the method comprising the steps of:
a. digitizing a received infrared signal;
b. transmitting the digitized signal over the digital network; and
c. reproducing the infrared signal as originally received.

13. The method of claim 12 further including the step of: sending the reproduced infrared signal to at least one electronic device.

14. The method of claim 12 wherein the network is wired.

15. The method of claim 12 wherein the network is wireless.

16. The method of claim 12 wherein the network is a powerline.

17. The method of claim 13 wherein the at least one electronic device comprises at least one of: a DVD player, a CD player, a cable box receiver, a satellite box receiver, a personal video recorder (PVR), a laserdisc player, a television, a personal computer, a home stereo, a home theater system, a game console, a personal digital assistant (PDA), and a mobile telephone.

18. The method of claim 12 further comprising the step of staggering the sending of two or more control signals to reduce the impact of simultaneously reproducing the control signals.

19. An apparatus for distributing and reproducing infrared signals within a digital network, the apparatus comprising:
a. means for digitizing a received infrared signal and transmitting the digitized signal over the digital network; and
b. means for receiving the digitized signal and reproducing the infrared signal as originally received.

20. The apparatus of claim 19 wherein the means for digitizing and transmitting comprises a control unit.

21. The apparatus of claim 19 wherein the means for receiving and reproducing comprises at least one transceiver device.

22. The apparatus of claim 19 further including means for displaying the reproduced infrared signal as originally received.

23. The apparatus of claim 22 wherein the means for displaying comprises at least one electronic device located within a vicinity of the means for receiving the digitized signal.

24. The apparatus of claim 19 wherein the network is wired.

25. The apparatus of claim 19 wherein the network is wireless.

26. The apparatus of claim 19 wherein the network is a powerline.

27. The apparatus of claim 23 wherein the at least one electronic device comprises at least one of: a DVD player, a CD player, a cable box receiver, a satellite box receiver, a personal video recorder (PVR), a laserdisc player, a television, a personal computer, a home stereo, a home theater system, a game console, a personal digital assistant (PDA), and a mobile telephone.

28. The apparatus of claim 19 further including means for staggering the sending of two or more control signals to reduce the impact of simultaneously reproducing the control signals.

29. An apparatus for controlling a plurality of electronic devices locatable in at least two rooms within a building and coupled to a digital network, the apparatus comprising a control unit coupled to the network for digitizing a received infrared signal and transmitting the digitized signal over the network to communicate with a plurality of transceiver devices coupled to the electronic devices, thereby establishing a two way communication between the control unit and the transceiver devices, wherein the transceiver devices reproduce the infrared signal as originally received and send the infrared signals to the electronic devices to be controlled.

30. A method of controlling a plurality of electronic devices locatable in at least two rooms within a building and coupled over a digital network, the method comprising the steps of:
a. digitizing a received infrared signal;
b. transmitting the digitized signal over the network to communicate with a plurality of transceiver devices coupled to the electronic devices;
c. reproducing the infrared signal as originally received; and
d. sending the infrared signal to the electronic devices to be controlled.

31. An infrared signal distribution and management system for controlling electronic devices, the system comprising:
a. at least one network IR device coupled to each electronic device to be controlled, the at least one network IR device including means for emitting coded infrared signals to control the electronic devices, means for being uniquely addressable, and means for addressing each network IR device to communicate signals;
b. an IR management element for accepting commands from a user, the IR management element including means for emitting the coded infrared signals to control the electronic devices directly, and means for addressing and instructing the at least one network IR device to emit infrared signals to control the electronic devices; and
c. means for transmitting information between the electronic devices.

32. The system of claim 31 wherein the electronic devices are consumer electronic devices comprising at least one of: a DVD player, a CD player, a cable box receiver, a satellite box receiver, a personal video recorder (PVR), a home stereo, a laserdisc player, a television, a personal computer, a home theater system, a game console, a personal digital assistant (PDA), and a mobile telephone.

33. The system of claim 32 wherein the consumer electronic devices have identical make and model type, and respond to identical sequences of the coded infrared signals.

34. The system of claim 31 wherein the IR management element comprises:
a. a user interface;
b. microprocessor circuitry for instructing the at least one network IR device to emit the coded infrared signals for controlling the electronic devices;
c. infrared circuitry for sensing infrared activity; and
d. network chips for addressing and communicating with the at least one network IR device.

35. The system of claim 31 wherein the at least one network IR device comprises:
a. infrared circuitry for sensing infrared activity;
b. infrared circuitry for emitting infrared signals; and
c. network chips for addressing and communicating with the IR management element, each network IR device, and the electronic devices.

36. The system of claim 31 wherein the means for transmitting is one of a local area network, a wide area network, and a cable network.

37. A method of distributing and managing infrared signals to control electronic devices, comprising the steps of:
a. receiving commands from a user through an IR management element;
b. sending instructions from the IR management element to network IR devices;
c. sending signals between the network IR devices;
d. emitting coded infrared signal commands to the electronic devices to be controlled; and
e. transmitting information between the electronic devices.

38. The method of claim 37 wherein the electronic devices are consumer electronic devices comprising at least one of: a DVD player, a CD player, a cable box receiver, a satellite box receiver, a personal video recorder (PVR), a home stereo, a laserdisc player, a television, a personal computer, a home theater system, a game console, a personal digital assistant (PDA), and a mobile telephone.

39. The method of claim 38 wherein the consumer electronic devices have identical make and model types, and respond to identical sequences of the coded infrared signals.

40. The method of claim 37 wherein the IR management element is comprised of:
a. a user interface;
b. microprocessor circuitry for instructing the network IR devices to emit the coded infrared signals for controlling the electronic devices;
c. infrared circuitry for sensing infrared activity; and
d. network chips for addressing and communicating with the network IR devices.

41. The method of claim 37 wherein the network IR devices are comprised of:
a. infrared circuitry for sensing infrared activity;
b. infrared circuitry for emitting the infrared signals; and
c. network chips for addressing and communicating with the IR management element, each network IR device, and the electronic devices.

42. The method of claim 37 wherein one of a local area network, a wide area network and a cable network is used for sending instructions from the IR management element to the network IR devices, sending signals between the network IR devices, and transmitting information between the electronic devices.

43. An infrared signal distribution and management system to control electronic devices, the system comprising:
a. means for receiving commands from a user through an IR management element;
b. means for sending instructions from the IR management element to network IR devices;
c. means for sending signals between the network IR devices;
d. means for emitting infrared signal commands from the IR management element and the network IR devices to the electronic devices to be controlled; and
e. means for transmitting information between the electronic devices.

44. The system of claim 43 wherein the electronic devices are consumer electronic devices comprising at least one of: a DVD player, a CD player, a cable box receiver, a satellite box receiver, a personal video recorder (PVR), a home stereo, a laserdisc player, a television, a personal computer, a home theater system, a game console, a personal digital assistant (PDA), and a mobile telephone.

45. The system of claim 44 wherein the consumer electronic devices have identical make and model types, and respond to identical sequences of the infrared signals.

46. The system of claim 43 wherein the IR management element is comprised of:
a. a user interface;
b. microprocessor circuitry for instructing the network IR devices to emit the infrared signals for controlling the electronic devices;
c. infrared circuitry for sensing infrared activity; and
d. network chips for addressing and communicating with the network IR devices.

47. The system of claim 43 wherein the network IR devices are comprised of:
a. infrared circuitry for sensing infrared activity;
b. infrared circuitry for emitting the infrared signals; and
c. network chips for addressing and communicating with the IR management element, each network IR device, and the electronic devices.

48. The system of claim 43 wherein the means for transmitting is one of a local area network, a wide area network, and a cable network.
